(19) United States
(12) Patent Application Publication
(10) Pub. No.: US 2018/0033261 A1
(43) Pub. Date: Feb. 1, 2018

(54) DENTAL PAIN AND DISCOMFORT NOTIFICATION SYSTEM

(71) Applicant: Jared A. Mayers, Cartersville, VA (US)

(72) Inventor: Jared A. Mayers, Cartersville, VA (US)

(21) Appl. No.: 15/656,701

(22) Filed: Jul. 21, 2017

Related U.S. Application Data
(60) Provisional application No. 62/368,281, filed on Jul. 29, 2016.

(51) Int. Cl. G08B 5/36; H04Q 1/28; A61G 15/10; A61C 1/00; A61C 17/06

(52) U.S. Cl. CPC G08B 5/36; A61C 1/0015; A61C 17/04; A61G 15/10; H04Q 1/28

(57) ABSTRACT

A dental pain and discomfort notification system for providing immediate feedback from a patient to a dentist, dental hygienist, or oral surgeon. The dental pain and discomfort notification system includes a notification panel mounted in proximity to a dental chair and an activation device. The activation device may be a hand-held device, such as a wireless remote, or may be mounted near the dental chair. The activation device includes one or more switches for activation by the patient. Each switch corresponds to a condition being experienced by the patient, such as pain, discomfort, or the need for suction. During a dental procedure, the switches may be activated by the patient to request a corresponding action by the dentist.

This application claims the priority of Provisional U.S. Patent Application Ser. No. 62/368,281 filed Jul. 29, 2016.

### FIELD OF THE INVENTION

This invention relates to devices for improving a patient's ability to communicate with a dental technician during dental procedures and specifically to a dental pain and discomfort notification system for providing immediate feedback from a patient to a dentist, dental hygienist, or oral surgeon.

### BACKGROUND

In order to maintain oral health of individuals, dental procedures are performed daily in various dental offices. Dental procedures include cleaning and polishing of teeth, grinding and filling cavities, installation of crowns, and removal of teeth.

When undergoing a dental procedure, it is difficult for patients to communicate their feelings with the dentist, hygienist, orthodontist, or oral surgeon. As an example, during a cleaning procedure by a hygienist, cleaning solution typically builds up in the patient's throat and must be frequently aspirated away by the hygienist. Unfortunately, when the patient requires aspiration, they must inform the hygienist audibly or by waving their hands or making a similar visible signal. It is difficult for the patient to inform the hygienist audibly as speaking is impossible as a result of the solution buildup in the throat. During a typical drilling procedure, mechanical equipment such as a dental drill is inserted in the mouth, and dental dams may be clamped around the tooth to keep it dry and free of saliva. As a result, the patient's throat is at least partially blocked and it is difficult for the patient to audibly inform the dentist if he is experiencing pain or discomfort.

Accordingly, what is needed is a system for enabling a dental patient to easily communicate their needs to the dentist, hygienist, or similar professional during a dental procedure. Such a system will enable a dental practitioner to pause a procedure as required to make the patient more comfortable.

### BRIEF SUMMARY OF THE INVENTION

The foregoing objectives are basically attained by a dental pain and discomfort notification system for providing immediate feedback from a patient to a dentist, dental hygienist, or oral surgeon. The dental pain and discomfort notification system includes a notification panel mounted in proximity to a dental chair and an activation device. The activation device may be a hand-held device, such as a wireless remote, or may be mounted near the dental chair. The activation device includes one or more switches for activation by the patient. Each switch corresponds to a condition being experienced by the patient, such as pain, discomfort, or the need for suction. During a dental procedure, the switches may be activated by the patient to request a corresponding action by the dentist.

### OBJECTS AND ADVANTAGES

A first object of the invention is to provide a non-verbal means of providing feedback from a patient to a dental practitioner.

A second object of the invention is to provide a means of providing immediate feedback from a patient to a dental practitioner.

A further object of the invention is to provide a notification system for a dentist's office that is capable of transmitting more than one condition to the dental provider.

Another object is to provide a dental pain and discomfort notification system that is capable of transmitting an audible signal from the patient to the dental practitioner.

A further object is to provide a dental pain and discomfort notification system that is capable of transmitting an audible signal coincidentally with a visual signal from the patient to the dental practitioner.

A further object of the current invention is to provide a dental pain and discomfort notification system that includes LED lights of various colors for providing a visual signal to a dental practitioner during a dental procedure.

These and other objects and advantages of the present invention will be understood by reading the following description along with reference to the drawings.

### BRIEF DESCRIPTION OF THE SEVERAL VIEWS OF THE DRAWING(S)

Reference is made herein to the accompanying drawings, which are not necessarily drawn to scale, and wherein:

FIG. 1 is a side elevation view of a first embodiment of a dental pain and discomfort notification system installed on a dental chair according to the present invention.

FIG. 2 is a top view of dental pain and discomfort notification system of FIG. 1.

FIG. 3 is a plan view of a signal activation box that forms a portion of the dental pain and discomfort notification system of FIG. 1.

FIG. 4 is a plan view of a dentist notification panel that forms a portion of the dental pain and discomfort notification system.

FIG. 4A is a plan view of the dentist notification panel with the top transparent cover peeled away.

FIG. 5 is a plan view of the signal activation box and a patient notification panel that forms a portion of the dental pain and discomfort notification system.

FIG. 5A is a plan view of the signal activation box and the patient notification panel with the top transparent cover of the patient notification panel peeled away.

FIG. 6 is a schematic of an electrical circuit for powering and controlling the dental pain and discomfort notification system of FIG. 1.

FIG. 7 is a side elevation view of a second embodiment of a dental pain and discomfort notification system installed on a dental chair according to the present invention.

FIG. 8 is a side elevation view of a hand held remote for powering and controlling the dental pain and discomfort notification system of FIG. 1.

FIG. 9 is a schematic of an alternative embodiment of an electrical circuit for powering and controlling the dental pain and discomfort notification system of FIG. 1.

FIG. 10 is a wiring diagram for powering and controlling the light emitting diodes (LEDs) of the dental pain and discomfort notification system of the present invention.

### DETAILED DESCRIPTION

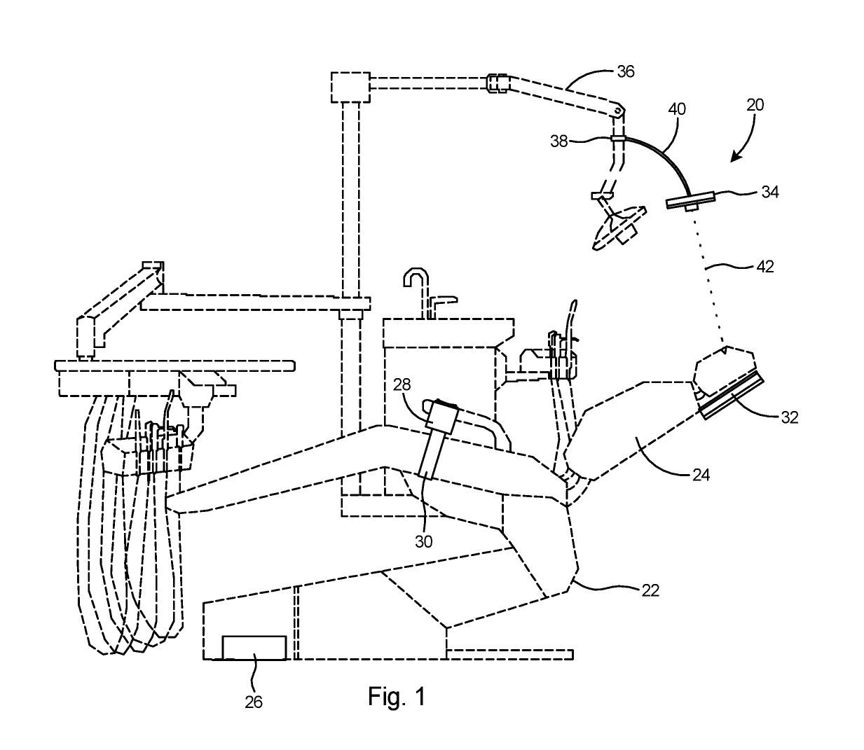

With reference to FIG. 1, there is shown a dental pain and discomfort notification system 20 installed on a dental chair 22 and including a dental patient 24 in the chair. The a dental pain and discomfort notification system 20 includes a power supply 26, a signal activation box 28 with associated activation box mount 30, a dentist notification panel 32, and a patient notification panel 34 secured to an overhead support 36 by a bracket 38 and a support arm 40. The dentist notification panel 32 is preferably mounted beside the patient's head or any similar position that would enable convenient observation during dental procedures by a dentist, a dental hygienist, an oral surgeon, or other dental personnel. The patient notification panel 34 is preferably mounted above the patient's head, preferably in a position to provide a sight line 42 for the patient to view the panel 34. Electrical circuitry connecting the power supply 26 to the signal activation box 28, to the dentist notification panel 32, and to the patient notification panel 34 is not shown in FIG. 1.

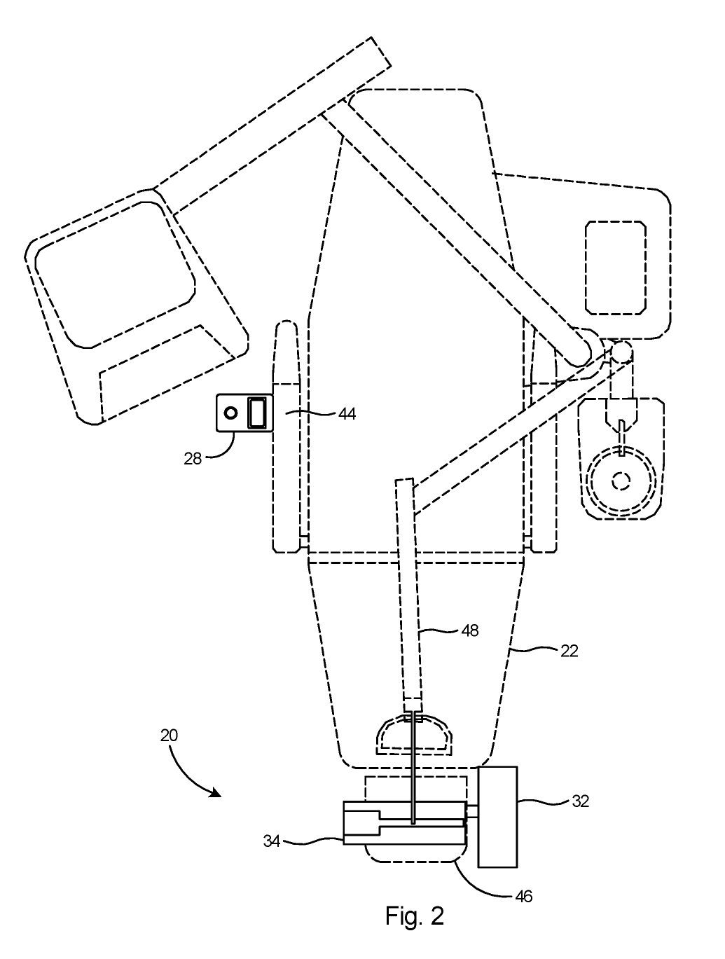

Referring to FIG. 2, there is shown a layout of the dental pain and discomfort notification system 20 on a dental chair 22. The signal activation box 28 is preferably mounted on an arm 44 of the dental chair, or can be mounted to the dental chair at any location that is convenient to the patient as the patient will be activating the system during dental procedures. It is also within the scope of the invention to provide a hand-held signal activation box that may be held by the patient during dental procedures. The dentist notification panel 32, shown mounted to the head rest 46 portion of the dental chair 22, may be mounted to the dental chair, to a separate floor stand (not shown), or any similar structure that enables observation by the dentist while performing a dental procedure on the patient. The patient notification panel 34 may be mounted to the lighting framework 48, to a stand, or to any convenient supporting structure that enables viewing during dental procedures.

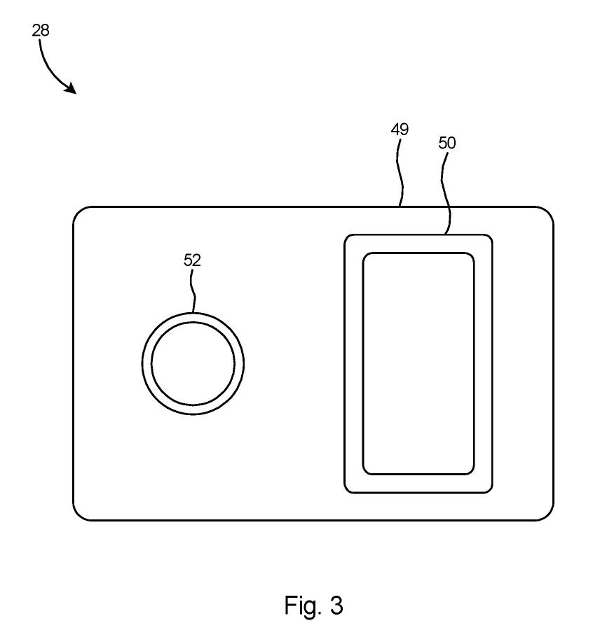

With reference to FIG. 3, signal activation box 28 includes a housing 49 for accommodating the associated electronics, a pain and discomfort switch 50, and a suction activation switch 52. In the embodiment of the activation box depicted in FIG. 3, the pain and discomfort switch 50 is a rocker switch and the suction activation switch 52 is a pushbutton switch, although other switch configurations, such as a toggle switch for the pain and discomfort switch, are within the scope of the invention.

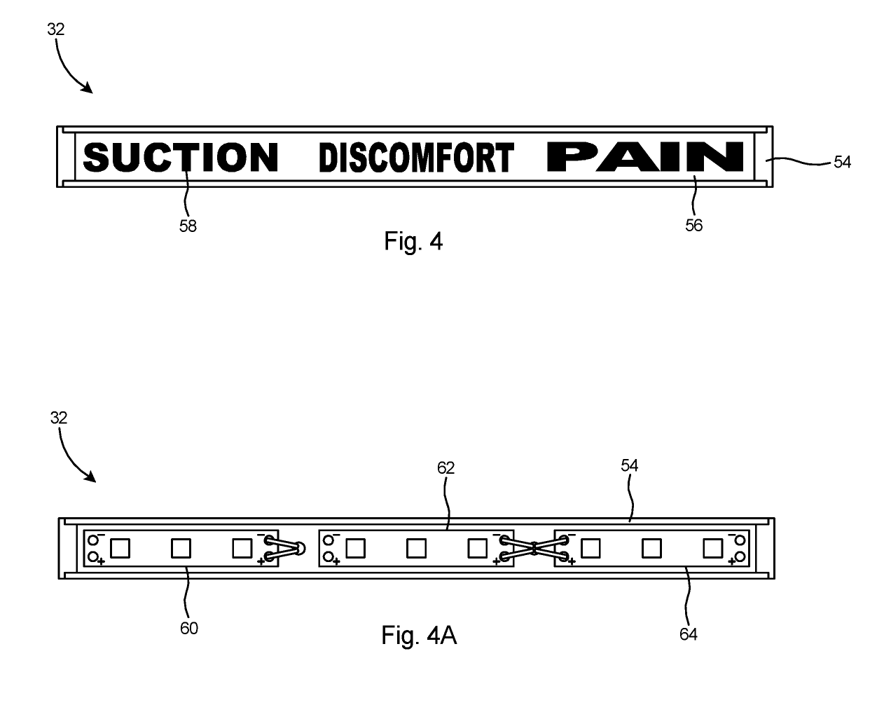

Referring to FIGS. 4 and 4A, dentist notification panel 32 includes a housing 54 and a top cover 56 that includes indicia 58 thereon, with the indicia indicating the physical conditions the patient is experiencing, such as “discomfort” or “pain”, or an action that the dental patient is requesting, such as “suction”. As verbal communication is difficult during many dental procedures, such as when the patient's mouth is full of water, cleaning solution, polishing solution, or similar liquids, or when clamps are fixed around the teeth, the dental pain and notification system enables the patient to instantaneously transmit instructions to the dentist. The dentist notification panel 32 includes three separately wired LED strips 60, 62, and 64 of separate colors which can be activated by a corresponding switch on the signal activation box. The power supply regulates voltage to 12 volts DC, that, depending on which switch is activated by the patient's action on the signal activation box, is supplied to the proper LED strip to illuminate the appropriate LED strip. Top cover 56 is preferably translucent enabling the proper indicia to be backlit with activation of the corresponding switch.

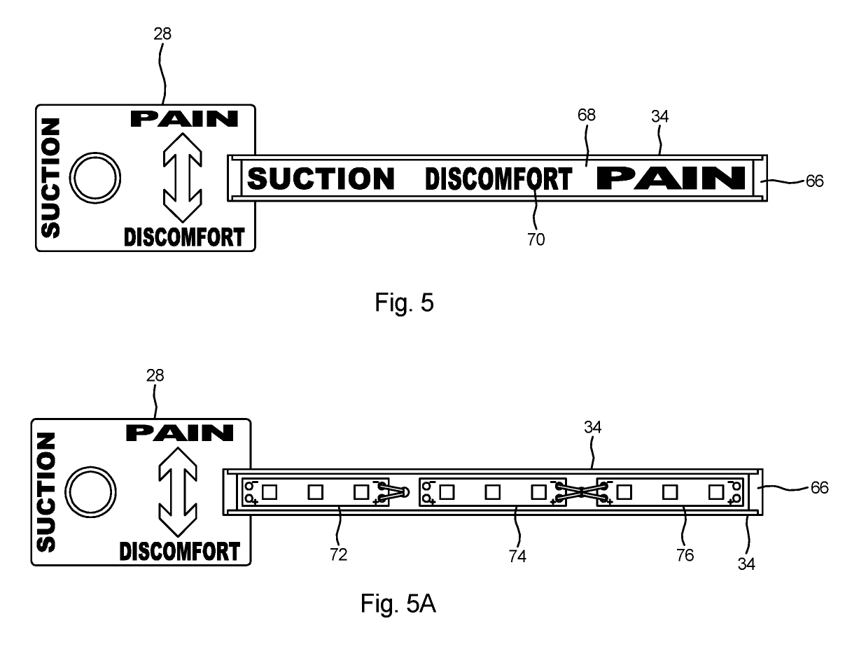

With reference to FIGS. 5 and 5A, the signal activation box 28 is mounted in a location convenient to manipulation by the patient or is a hand-held device. The patient notification panel 34 is constructed similar to the dentist notification panel including a housing 66 and a top cover 68 with indicia 70 thereon, with the indicia again indicating either “discomfort”, “pain”, or “suction”. The patient notification panel 34 includes three separately wired LED strips 72, 74, and 76. As the patient manipulates a switch on the signal activation box 28, the electronic circuit instantaneously activates backlighting of the corresponding LED strip on both the patient notification panel 34 and the dentist notification panel 32, thereby enabling the dentist to take the appropriate action.

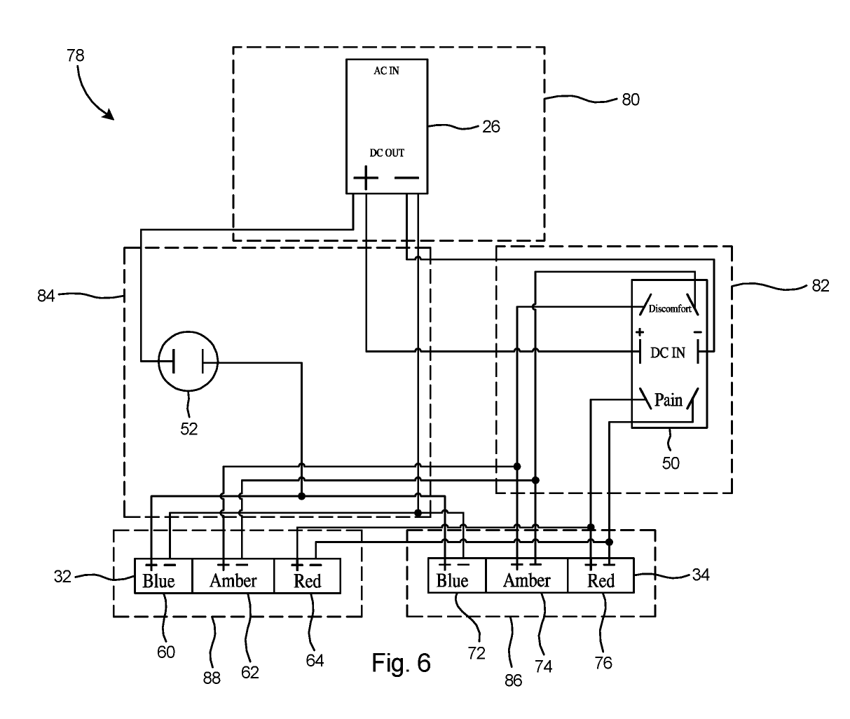

Referring to FIG. 6, an electronic circuit 78 controls the various components of the dental pain and discomfort notification system. The electronic circuit 78 includes a power supply circuit 80, a pain and discomfort switching circuit 82, a suction switching circuit 84, a patient notification circuit 86, and a dentist notification circuit 88. The power supply 26 converts AC voltage to 12 volts DC which, depending on the patient's action, is supplied to the LEDs through the appropriate switching circuit. The pain and discomfort switching circuit 82 includes the pain and discomfort switch 50 and the suction switching circuit 84 includes the suction activation switch 52. In the preferred embodiment of the notification panels, blue LED lights are used to backlight the “suction” indicia, “amber” LEDs are used to backlight the “discomfort” indicia, and “red” LEDs are used to backlight the “pain” LEDs. The output supply voltage from each of the three conditions are wired in common to the appropriate LED strip, including LED strips 60, 62, and 64 for the dentist notification panel 32 and LED strips 72, 74, and 76 for the patient notification panel 34.

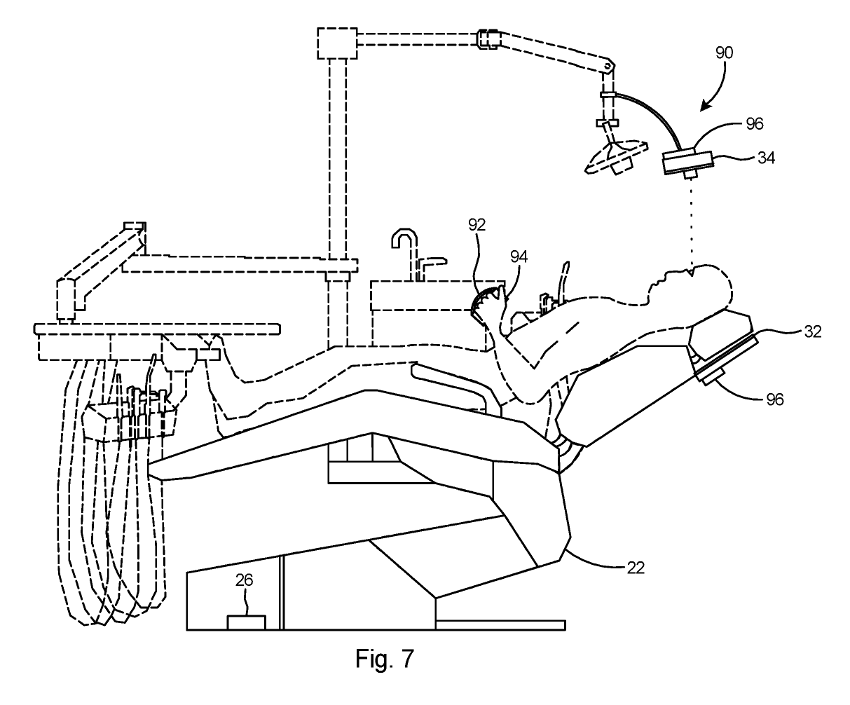

With reference to FIG. 7, there is shown a second embodiment of a dental pain and discomfort notification system 90 installed on a dental chair 22 and including a power supply 26, a hand-held activator 92, a dentist notification panel 32, and a patient notification panel 34. In this embodiment of the dental pain and discomfort notification system 90, the hand-held activator 92 may include three separate pushbuttons, or similar switching devices, to control the electronic output to the two notification panels. Hand-held activator 92 includes an RF transmitter 94 and an RF receiver 96 is included with the dentist notification panel 32 and with the patient notification panel 34. Manipulation of the hand-held activator 92 by the dental patient 24 activates the selected switch which in turn backlights the appropriate section of both the dentist notification panel 32 and the patient notification panel 34. The discomfort notification system 90 thus eliminates the need for the patient to verbally communicate the details of his or her condition to the dentist.

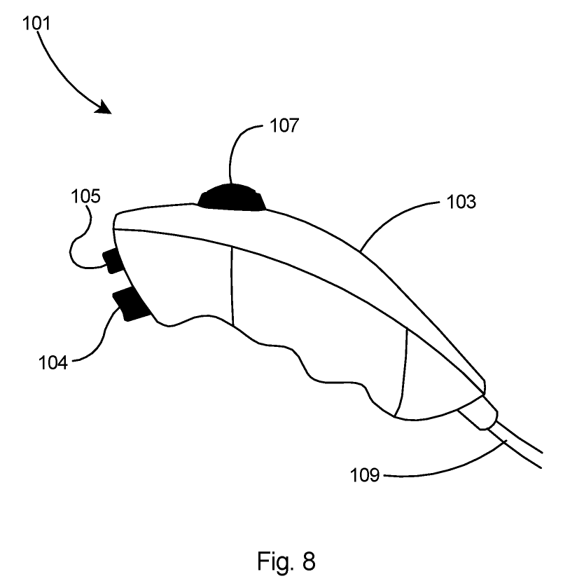

Referring to FIG. 8, the dental pain and discomfort notification system may include a remote controller 101 in place of the signal activation box. The remote 101 includes a housing 103 for accommodating the associated electronics, a pain activation button 104, a discomfort activation button 105, and a suction activation button 107. In the embodiment of the remote depicted in FIG. 8, the remote 101 includes an electrical cable 109 for transmitting signals to the notification panel or panels. More preferably, remote is a wireless remote and each of the activation buttons activates a radio frequency (RF) signal which is picked up by an RF receiver in the notification panel and in turn activates the respective LED and/or activates an audible alarm such as a buzzer.

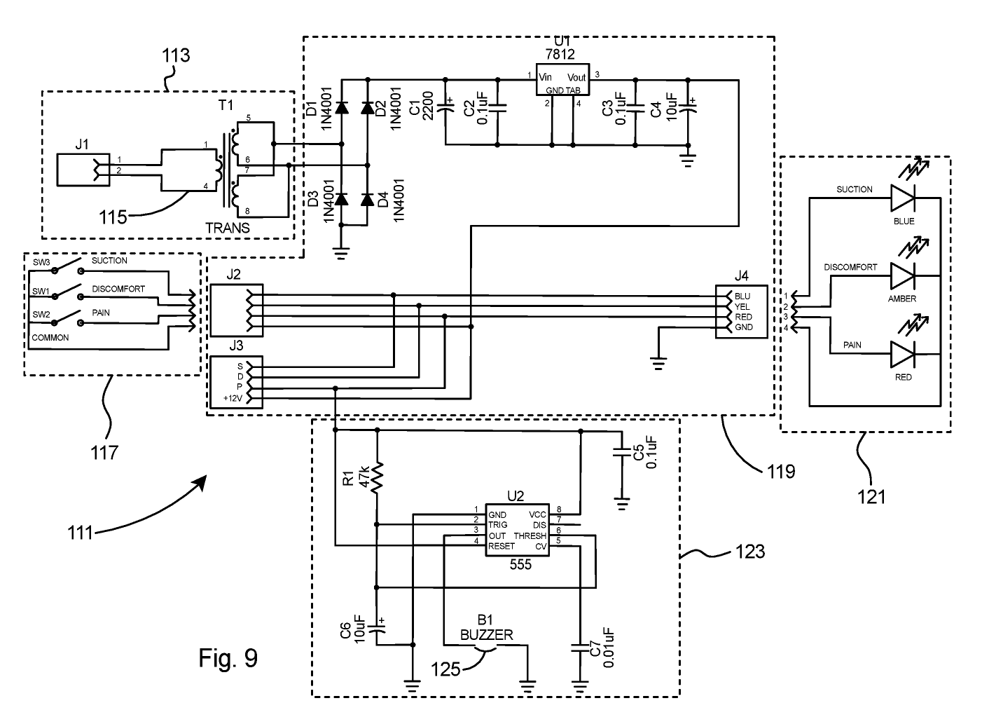

With respect to FIG. 9, a control circuit 111 powers and controls the various components of the dental pain and discomfort notification system. The control circuit 111 includes a power supply circuit 113 having a transformer 115 for converting line voltage to an operating voltage, such as a lower DC operating voltage, a remote circuit 117, a switching circuit 119, a notification panel 121, and an audible alarm switching circuit 123 including a buzzer 125 or similar device for producing an audible alarm upon activation of any of the pushbuttons, rocker switches, or similar activation devices on the remote or on the signal activation box.

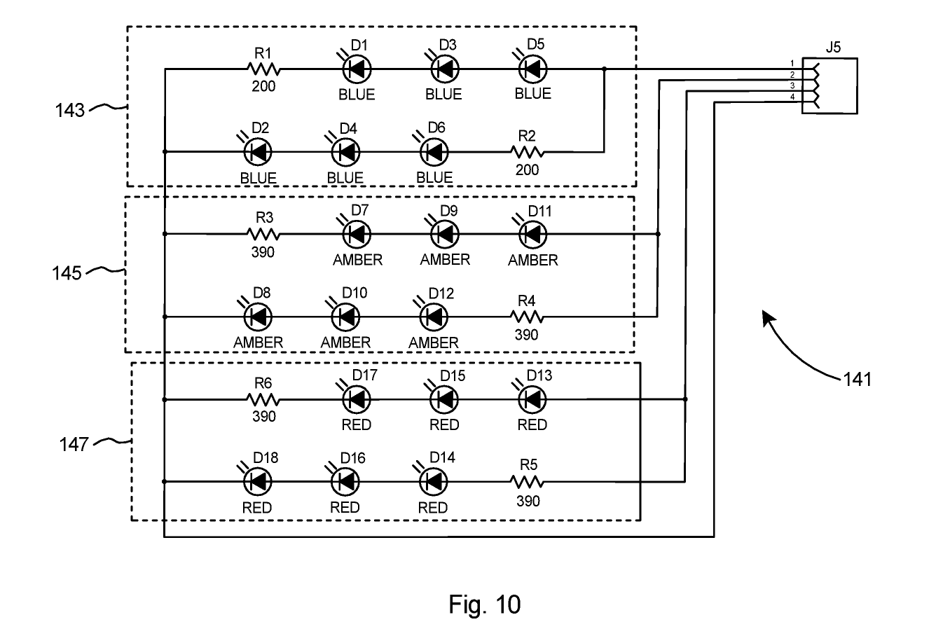

Referring to FIG. 10, an LED circuit 141 for powering and controlling the light emitting diodes (LEDs) of the dental pain and discomfort notification system include a blue LED circuit 143 for, upon activation, powering and backlighting the “suction” indicia section of the notification panel, an amber LED circuit 145 for powering and backlighting the “discomfort” indicia section of the notification panel upon activation, and a red LED circuit 147 for powering and backlighting the “pain” indicia section of the notification panel upon activation,

Having thus described the invention with reference to a preferred embodiment, it should be understood that the description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments herein were chosen and described in order to best explain the principles of the invention and the practical application, and to enable others of ordinary skill in the art to understand the invention.

What is claimed is:

1. A dental pain and discomfort notification system, comprising:
a notification panel;
an activation device;
a power supply for powering the notification panel;
a light emitting diode (LED) on the notification panel; and
a control circuit for transmitting electronic signals from the activation device to the notification panel.

2. The dental pain and discomfort notification system of claim 1, wherein said activation device is a remote controller.

3. The dental pain and discomfort notification system of claim 2, wherein said remote controller further comprises:
a pain activation button;
a discomfort activation button; and
a suction activation button.

4. The dental pain and discomfort notification system of claim 1, further comprising an audible alarm for broadcasting a sound upon receipt of electronic signals from the activation device.

5. The dental pain and discomfort notification system of claim 1, wherein said control circuit further comprises a power supply circuit including a transformer for converting a line voltage to a an operating voltage.

6. The dental pain and discomfort notification system of claim 1, wherein said control circuit further comprises a remote circuit for remotely activating the LED on the notification panel.

7. The dental pain and discomfort notification system of claim 1, wherein said control circuit further comprises:
a switching circuit; and
an audible alarm switching circuit including a buzzer.

8. The dental pain and discomfort notification system of claim 3, further comprising:
a first LED strip activated by the pain activation button;
a second LED strip activated by the discomfort activation button; and
a third LED strip activated by the suction activation button.

9. A dental pain and discomfort notification system, comprising:
a patient notification panel;
a dentist notification panel;
an activation device;
a power supply for powering the notification panels;
a plurality of light emitting diode (LED) strips on the notification panels; and
a control circuit for concurrently transmitting electronic signals from the activation device to the notification panels.

10. The dental pain and discomfort notification system of claim 9, wherein said activation device is a remote controller.

11. The dental pain and discomfort notification system of claim 10, wherein said remote controller further comprises:
a pain activation button;
a discomfort activation button; and
a suction activation button.

12. The dental pain and discomfort notification system of claim 9, further comprising an audible alarm for broadcasting a sound upon receipt of electronic signals from the activation device.

13. The dental pain and discomfort notification system of claim 9, wherein said control circuit further comprises a power supply circuit including a transformer for converting a line voltage to a an operating voltage.

14. The dental pain and discomfort notification system of claim 11, wherein said control circuit further comprises a remote circuit for remotely illuminating one of the plurality of LED strips on the notification panels based upon activation of a corresponding activation button.

15. The dental pain and discomfort notification system of claim 9, wherein said control circuit further comprises:
a switching circuit; and
an audible alarm switching circuit including a buzzer.

16. The dental pain and discomfort notification system of claim 11, wherein said notification panels further comprise:
a first LED strip activated by the pain activation button;
a second LED strip activated by the discomfort activation button; and
a third LED strip activated by the suction activation button.

17. The dental pain and discomfort notification system of claim 16, further comprising said first, second, and third LED strips are of different colors.

18. A dental pain and discomfort notification system, comprising:
a dental chair including a notification panel;
a light emitting diode (LED) strip on the notification panel;
an activation device for activating the LED strip;
a power supply for powering the notification panel; and
a control circuit for transmitting electronic signals from the activation device to the notification panel.

19. The dental pain and discomfort notification system of claim 18, wherein said activation device is a remote controller comprising:
a pain activation button;
a discomfort activation button; and
a suction activation button.

20. The dental pain and discomfort notification system of claim 19, wherein said notification panel further comprises an LED strip corresponding to each of said activation buttons on said remote controller.
